(19) United States
(12) Patent Application Publication
(10) Pub. No.: US 2011/0052853 A1
(43) Pub. Date: Mar. 3, 2011

(54) ADHESIVE FILM WITH DICING SHEET AND METHOD OF MANUFACTURING THE SAME

(76) Inventors: Yuki SUGO, Osaka (JP); Yasuhiro AMANO, Osaka (JP); Takeshi MATSUMURA, Osaka (JP); Shuuhei MURATA, Osaka (JP)

(21) Appl. No.: 12/871,523

(22) Filed: Aug. 30, 2010

(30) Foreign Application Priority Data
Aug. 31, 2009 (JP) 2009-200201

(51) Int. Cl. C09J 7/00; B32B 7/12; B32B 33/00; B32B 37/14

(52) U.S. Cl. 428/41.8; 428/354; 156/60

(57) ABSTRACT

The present invention provides an adhesive film with a dicing sheet having a pressure-sensitive adhesive layer on a base material and also having a peelable adhesive film on the pressure-sensitive adhesive layer, that has an excellent peeling property when peeling a semiconductor chip obtained by dicing and an adhesive film attached thereto together without impairing the holding power even during dicing a thin semiconductor wafer, and a method of manufacturing the same. The adhesive film with a dicing sheet of the present invention is formed by sequentially laminating a pressure-sensitive adhesive layer and an adhesive layer on a base material, in which the intensity of an Si—Kα ray on at least one region on a surface of the pressure-sensitive adhesive layer to be pasted onto the adhesive layer is 0.01 to 100 kcps.

### BACKGROUND OF THE INVENTION

1. Field of the Invention

The present invention relates to an adhesive film with a dicing sheet that is used in dicing of a semiconductor wafer with an adhesive for fixing a semiconductor chip and an electrode member together provided on the semiconductor wafer before dicing, and a method of manufacturing the same. The present invention also relates to a semiconductor device that is manufactured using the adhesive film with a dicing sheet.

2. Description of the Related Art

A semiconductor wafer with a circuit pattern has its thickness adjusted by backside polishing as necessary and then is diced into semiconductor chips (a dicing step). In the dicing step, the semiconductor wafer is generally washed at an appropriate liquid pressure (normally about 2 kg/cm²) to remove the cut layer. Then the semiconductor chips are fixed to an adherend such as a lead frame with an adhesive (a mounting step) and transferred to a bonding step. In the mounting step, conventionally an adhesive is applied onto the lead frame or the semiconductor chips. However, in this method, it is difficult to make a uniform adhesive layer, and a special apparatus and a lengthy time are required for the application of the adhesive. Accordingly, a dicing die bond film has been proposed in which an adhesive layer for fixing a chip necessary for the mounting step is provided while keeping the adhesion of the semiconductor wafer in the dicing step (for example, refer to Japanese Patent Application Laid-Open No. 60-57642).

The dicing die bond film described in Japanese Patent Application Laid-Open No. 60-57642 is formed by providing a peelable adhesive layer on a base material 1. That is, a semiconductor wafer is diced while being held by the adhesive layer, the semiconductor chips are peeled together with the adhesive layer by stretching the base material 1, and the chips are individually collected and fixed to an adherend such as a lead frame through the adhesive layer.

A good holding power to the semiconductor wafer so that dicing difficulties, dimensional errors, and the like do not occur and a good peeling property so that the semiconductor chip and the adhesive layer after dicing can be peeled together from the base material 1 are desired for the adhesive layer of the dicing die bond film of this type. However, it is not easy to balance these characteristics.

Various improved methods have been proposed to overcome such problems. For example, a method has been proposed in Japanese Patent Application Laid-Open No. 2-248064 in which pickup of the semiconductor chip is made easy by interposing an ultraviolet curable pressure-sensitive adhesive layer between the base material 1 and the adhesive layer, curing the pressure-sensitive adhesive layer with an ultraviolet ray after dicing to decrease the adhering strength between the pressure-sensitive adhesive layer and the adhesive layer, and peeling these layers away from each other.

However, it is difficult to satisfy the high tackiness that is necessary during dicing and the peeling property that is necessary during pickup at the same time, and it is also difficult to peel a semiconductor chip with an adhesive from a dicing sheet as the semiconductor wafer becomes larger (10 mm×10 mm or more) and thinner (about 15 to 100 μm). As a result, there is a problem of damages due to poor pickup and deformation of the chip.

### SUMMARY OF THE INVENTION

The present invention aims to provide an adhesive film with a dicing sheet having a pressure-sensitive adhesive layer on a base material and having a peelable adhesive film on the pressure-sensitive adhesive layer, in which the dicing sheet has an excellent peeling property when peeling a semiconductor chip obtained by dicing and an adhesive film attached thereto together without impairing the holding power even during dicing a thin semiconductor wafer, and a method of manufacturing the same.

The present inventors investigated an adhesive film with a dicing sheet and a method of manufacturing the same in order to solve the conventional problems. As a result, it was found that the object can be achieved by adopting the following configuration and thus the present invention was completed.

That is, in order to solve the above-described problems, the adhesive film with a dicing sheet according to the present invention is an adhesive film with a dicing sheet in which a pressure-sensitive adhesive layer and an adhesive layer are sequentially laminated on a base material and in which the intensity of an Si—Kα ray on at least one region on the surface of the pressure-sensitive adhesive layer to be pasted onto the adhesive layer is 0.01 to 100 kcps.

The intensity of the Si—Kα ray in the above-described configuration can be an indicator to show how many silicon atoms exist in the pasting surface of the pressure-sensitive adhesive layer. Because the pasting surface is modified so that the intensity of the Si—Kα ray becomes 0.01 kcps or more, the peeling property to the adhesive layer can be maintained. Accordingly, the generation of adhesive residue and pickup failure can be prevented during pickup of the semiconductor chips, for example. Meanwhile, by modifying the pasting surface so that the intensity of the Si—Kα ray becomes 100 kcps or less, an excessive decrease of tackiness to the adhesive layer is prevented. Accordingly, the semiconductor chip obtained from the dicing step can be securely adhered and fixed even when dicing a semiconductor wafer pasted onto the adhesive layer, for example. As a result, the generation of chip fly and chipping can be prevented.

In this configuration, the peel adhesion in the above-described region is preferably 0.01 to 0.2 N/20 mm to the adhesive layer when the pressure-sensitive adhesive layer is peeled from the adhesive layer at a temperature of 25° C., a relative humidity of 55%, a tensile speed of 300 ram/min, and a peeling angle of 180°. The peel adhesion of the pressure-sensitive adhesive layer to the adhesive layer can be controlled within a range of 0.01 to 0.2 N/20 mm by modifying at least one region of the pasting surface of the pressure-sensitive adhesive layer so that the intensity of the Si—Kα ray becomes 0.01 to 100 kcps. With the peel adhesion being 0.01 N/20 mm or more, an excessive decrease of the tackiness to the adhesive layer is prevented. On the other hand, with the peel adhesion being 0.2 N/20 mm or less, excessive adhesion to the adhesive layer can be prevented. Accordingly, a good peeling property can be maintained between the pressure-sensitive adhesive layer and the adhesive layer. As a result, the generation of adhesive residue and pickup failure can be presented during pickup of the semiconductor chips, for example.

In this configuration, the above-described region preferably corresponds to the region of the adhesive layer onto which a workpiece is to be pasted. The semiconductor wafer pasting region of the adhesive layer means a region onto which the semiconductor wafer is pasted. With such a configuration, the generation of chip fly and chipping can be prevented during dicing of the semiconductor wafer, and the pickup property can be kept good.

Further, in order to solve the above-described problems, the method of manufacturing an adhesive film with a dicing sheet according to the present invention is a method of manufacturing an adhesive film with a dicing sheet in which a pressure-sensitive adhesive layer and an adhesive layer are sequentially laminated on a base material, which includes the steps of forming a pressure-sensitive adhesive layer on a base material, modifying at least one region of the surface of the pressure-sensitive adhesive layer so that the intensity of an Si—Kα ray becomes 0.01 to 100 kcps, and forming an adhesive layer on the modified surface on the pressure-sensitive adhesive layer.

By surface-modifying at least one region of the pressure-sensitive adhesive layer formed on the base material so that the intensity of an Si—Kα ray becomes 0.01 to 100 kcps in the above-described method, a good balance of tackiness and the peeling property to the adhesive layer that is formed after the surface modification can be easily produced. As a result, the generation of chip fly and chipping of the semiconductor chip during dicing of the semiconductor wafer can be prevented, and the generation of adhesive residue and pickup failure during pickup of the semiconductor chips can also be prevented at the same time.

For the modification of the pasting surface of the pressure-sensitive adhesive layer, a modification method by spraying a solution containing at least a silicone resin in mist form, a modification method by transferring a film to which a silicone resin is applied onto another film, and a modification method by applying a silicone dispersion onto the surface of the pressure-sensitive adhesive layer and drying the dispersion are preferable. Especially with the method of spraying a solution containing at least a silicone resin in mist form, the step of the surface modification can be easily performed and workability can be improved.

Further, in order to solve the above-described problems, the semiconductor device according to the present invention is manufactured using the adhesive film with a dicing sheet.

The present invention provides the following effects by the means explained above.

That is, the adhesive film with a dicing sheet of the present invention has a structure in which a pressure-sensitive adhesive layer and an adhesive layer are sequentially laminated on a base material and at least one region of the pasting surface of the pressure-sensitive adhesive layer to the adhesive layer is modified. By modifying the surface so that the intensity of an Si—Kα ray becomes 0.01 to 100 kcps, a good balance of tackiness and the peeling property between the pressure-sensitive adhesive layer and the adhesive layer can be achieved. As a result, the generation of chip fly and chipping of the semiconductor chip during dicing of the semiconductor wafer can be prevented, and the generation of adhesive residue and pickup failure during pickup of the semiconductor chips can also be prevented at the same time. Therefore, manufacturing throughput can be improved.

### BRIEF DESCRIPTION OF THE DRAWINGS

FIG. 1 is a schematic sectional drawing showing an adhesive film with a dicing sheet according to one embodiment of the present invention;

FIG. 2 is a schematic sectional drawing showing the adhesive film with a dicing sheet according to another embodiment of the present invention;

FIG. 3 is a schematic sectional drawing showing an example in which a semiconductor chip is mounted with the adhesive film interposed according to one embodiment of the present invention;

FIG. 4 is a schematic sectional drawing showing an example in which a semiconductor chip is three-dimensionally mounted with the adhesive film interposed; and

FIG. 5 is a schematic sectional drawing showing an example in which two semiconductor chips are mounted interposing a spacer using the adhesive film.

### DESCRIPTION OF THE EMBODIMENTS

(Adhesive Film with Dicing Sheet)

The adhesive film with a dicing sheet according to the present embodiment is explained in the following.

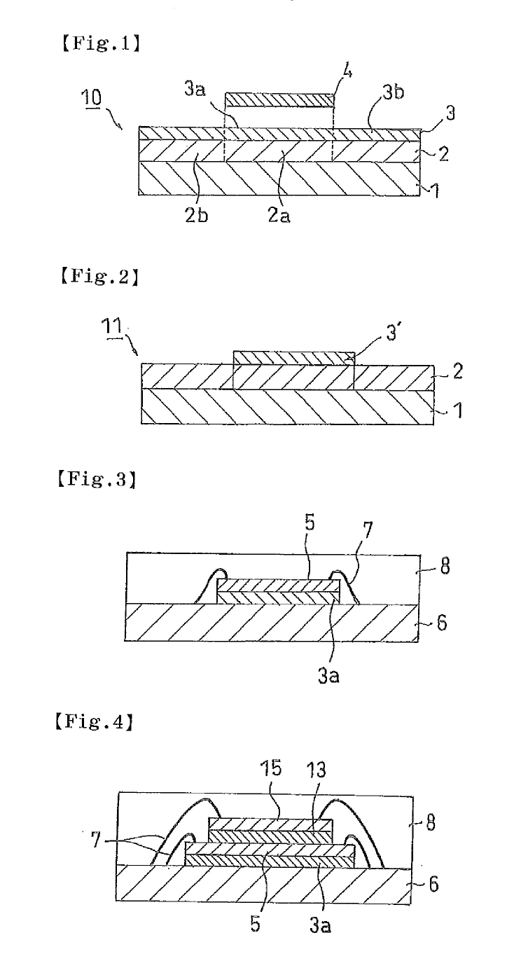

As shown in FIG. 1, an adhesive film with a dicing sheet 10 has a configuration in which a pressure-sensitive adhesive layer 2 and an adhesive layer 3 are sequentially laminated on a base material 1. The laminate may have a configuration in which an adhesive layer 3′ is formed only on a pasting portion of the semiconductor wafer as shown in FIG. 2. The adhesive layers 3 and 3′ correspond to an adhesive film in the present specification.

The adhesive film of the present invention can be used as a die bond film or a film for a backside of a flip-chip semiconductor. The film for a backside of a flip-chip semiconductor is used to be formed on the backside of a semiconductor element (for example, a semiconductor chip) that is flip-chip-connected onto an adherend (for example, various types of substrates such as a lead frame and a circuit board).

The pasting surface of the pressure-sensitive adhesive layer 2 to the adhesive layer 3 is modified so that the intensity of the Si—Kα ray becomes preferably 0.01 to 100 kcps, more preferably 0.05 to 50 kcps, and especially preferably 0.1 to 10 kcps. With the intensity of the Si—Kα ray being 100 kcps or less, the tackiness of the pressure-sensitive adhesive layer 2 to the adhesive layer 3 can be prevented from excessively decreasing. As a result, the chip fly and chipping of semiconductor chips can be prevented from being generated when the semiconductor chips are formed by dicing the semiconductor wafer pasted onto the adhesive layer 3, for example. Meanwhile, with the intensity of the Si—Kα ray being 0.01 kcps or more, an excessive decrease of the peeling property of the pressure-sensitive adhesive layer 2 to the adhesive layer 3 is suppressed. As a result, the residue of the pressure-sensitive adhesive that constitutes the pressure-sensitive adhesive layer 2 can be prevented from being generated during pickup of the semiconductor chips, for example. Further, pickup failure can be decreased, and the yield can be improved.

The intensity of the Si—Kα ray is a value that is measured by X-ray florescence analysis. An analyzer such as ZSX100e manufactured by Rigaku Corporation can be used. The measurement can be performed using a vertical Rh tube under conditions of an analysis area 300 mmφ, a dispersive crystal of RX4, and an output 50 kV and 70 mA.

The peel adhesion in the modified region in the pasting surface of the pressure-sensitive adhesive layer 2 can be made within a range of 0.01 to 0.2 N/20 mm to the adhesive layer by modifying the surface so that the intensity of an Si—Kα ray becomes 0.01 to 100 kcps. With the peel adhesion being 0.01 N/20 mm or more, an excessive decrease of tackiness to the adhesive layer 3 can be prevented. Meanwhile, with the peel adhesion being 0.2 N/20 mm or less, excessive adhesion to the adhesive layer 3 can be prevented. The peel adhesion is more preferably within a range of 0.015 to 0.18 N/20 mm. The peel adhesion is a value that is measured when peeling is performed at a temperature of 25° C., a relative humidity of 55%, a tensile speed of 300 mm/min, and a peeling angle of 180°.

Silicon atoms originating from the silicone resin exist in the region where the surface of the pressure-sensitive adhesive layer 2 is modified as a result of spraying of a solution containing a silicone resin as a releasing agent in mist form, for example. The surface-modified region of the pressure-sensitive adhesive layer 2 is not especially limited as long as it is the pasting surface to the adhesive layer 3. However, it is preferable to surface-modify a portion 2a that corresponds to a semiconductor wafer pasting portion 3a of the adhesive layer 3. When only a portion 2b that corresponds to a portion 3b that does not contribute to pasting of the semiconductor wafer is surface-modified, a good balance between the tackiness and the peeling property of the pressure-sensitive adhesive layer 2 to the adhesive layer 3 cannot be maintained. As a result, chip fly and pickup failure occur during dicing.

Examples of the silicone resin include silicon oil, silicone rubber, and dimethylpolysiloxane. Among these, silicone oil is preferable from the viewpoint of workability.

A difference in the degree of the surface modification may be created between the portion 2a and the portion 2b in the pressure-sensitive adhesive layer 2. Specifically, the surface is modified so that the intensity of an Si—Kα ray in the portion 2b becomes 0.01 to 100 kcps, and more preferably 0.05 to 50 kcps. With the intensity being in this range, the adhesive strength of the portion 2a to the adhesive layer 3 can be controlled to become smaller than the adhesive strength of the portion 2b to the adhesive layer 3. Specifically, it can be within a range of 0.01 to 0.2 N/20 mm, more preferably within a range of 0.012 to 0.19 N/20 mm, and especially preferably within a range of 0.015 to 0.18 N/20 mm. The condition of measuring the adhesive strength is the same as above. With such a configuration, a dicing ring to be pasted onto the portion 2b in the pressure-sensitive adhesive layer 2 can be securely fixed onto an adhesive film with a dicing sheet 11 shown in FIG. 2, for example.

The region to be surface-modified may or may not be formed uniformly such that the intensity of the Si—Kα ray falls within a range of 0.01 to 100 kcps on the pasting surface with the adhesive layer 3. A surface-modified region and a non-surface-modified region may coexist in a belt shape or a concentric circle shape. When the entire pasting surface with the adhesive layer 3 is modified, it is preferable not to form a thick silicone resin layer. If such a silicone resin layer is formed, the tackiness of the pressure-sensitive adhesive layer 2 may be impaired.

Next, each member that constitutes the adhesive film with a dicing sheet 10 according to the present embodiment is described in detail.

The base material 1 serves as a strength base of the adhesive films with dicing sheets 10 and 11. Examples thereof include polyolefin such as low-density polyethylene, straight chain polyethylene, intermediate-density polyethylene, high-density polyethylene, very low-density polyethylene, random copolymer polypropylene, block copolymer polypropylene, homopolypropylene, polybutene, and polymethylpentene; an ethylene-vinylacetate copolymer; an ionomer resin; an ethylene(meth)acrylic acid copolymer; an ethylene(meth)acrylic acid ester(random or alternating)copolymer; an ethylene-butene copolymer; an ethylene-hexene copolymer; polyurethane; polyester such as polyethyleneterephthalate and polyethylenenaphthalate; polycarbonate; polyetheretherketone; polyimide; polyetherimide; polyamide; whole aromatic polyamides; polyphenylsulfide; aramid (paper); glass; glass cloth; a fluorine resin; polyvinyl chloride; polyvinylidene chloride; a cellulose resin; a silicone resin; metal (foil); and paper. When the pressure-sensitive adhesive layer 2 is of an ultraviolet curing type, a base material having ultraviolet transmissivity is preferably adopted as the base material 1.

An example of a material of the base material 1 is a polymer such as a cross-linked body of the resins described above. The plastic films may be used in a non-stretched state or may be used in a uniaxially or biaxially stretched state as necessary. With a resin sheet to which a heat shrinking property is imparted by a stretching treatment or the like, the adhering area of the pressure-sensitive adhesive layer 2 to the adhesive layers 3 and 3′ can be reduced by heat-shrinking the base material 1 after dicing, and the semiconductor chips can be collected easily.

A known surface treatment such as a chemical or physical treatment such as a chromate treatment, ozone exposure, flame exposure, high voltage electric exposure, and an ionized ultraviolet treatment, and a coating treatment by an undercoating agent (for example, a tacky substance described later) can be performed on the surface of the base material 1 in order to improve adhesiveness, holding properties, etc. with the adjacent layer.

The same type or different type of base material can be appropriately selected and used as the base material 1, and a base material in which a plurality of types are blended can be used depending on necessity. Further, a vapor-deposited layer of a conductive substance composed of a metal, an alloy, an oxide thereof, etc. and having a thickness of about 30 to 500 angstrom can be provided on the base material 1 in order to give an antistatic function to the base material 1. The base material 1 may be a single layer or a multi layer of two or more types.

The thickness of the base material 1 can be appropriately decided without limitation particularly. However, it is generally about 5 to 200 μm.

The pressure-sensitive adhesive used for the formation of the pressure-sensitive adhesive layer 2 is not especially limited, and general pressure-sensitive adhesives such as an acrylic pressure-sensitive adhesive and a rubber pressure-sensitive adhesive can be used. An acrylic pressure-sensitive adhesive containing an acrylic polymer as a base polymer is preferable as the pressure-sensitive adhesive from the viewpoint of cleaning and washing properties of an electronic part such as a semiconductor wafer or a glass part that dislike contamination with ultrapure water or an organic solvent such as alcohol.

An example of the acrylic polymer is a polymer containing an acrylic ester as a main monomer component. Specific examples of the acrylic ester include an acryl polymer in which acrylate is used as a main monomer component. Examples of the acrylate include alkyl acrylate (for example, a straight chain or branched chain alkyl ester having 1 to 30 carbon atoms, and particularly 4 to 18 carbon atoms in the alkyl group such as methylester, ethylester, propylester, isopropylester, butylester, isobutylester, sec-butylester, t-butylester, pentylester, isopentylester, hexylester, heptylester, octylester, 2-ethylhexylester, isooctylester, nonylester, decylester, isodecylester, undecylester, dodecylester, tridecylester, tetradecylester, hexadecylester, octadecylester, and eicosylester) and cycloalkyl acrylate (for example, cyclopentylester, cyclohexylester, etc.). These monomers may be used alone or two or more types may be used in combination. All of the words including “(meth)” in connection with the present invention have an equivalent meaning.

The acrylic polymer may optionally contain a unit corresponding to a different monomer component copolymerizable with the above-mentioned alkyl ester of (meth) acrylic acid or cycloalkyl ester thereof in order to improve the cohesive force, heat resistance or some other property of the polymer. Examples of such a monomer component include carboxyl-containing monomers such as acrylic acid, methacrylic acid, carboxyethyl (meth)acrylate, carboxypentyl(meth)acrylate, itaconic acid, maleic acid, fumaric acid, and crotonic acid; acid anhydride monomers such as maleic anhydride, and itaconic anhydride; hydroxyl-containing monomers such as 2-hydroxyethyl (meth) acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxylmethylcyclohexyl)methyl(meth)acrylate; sulfonic acid group containing monomers such as styrenesulfonic acid, allylsulfonic acid, 2-(meth)acrylamide-2-methylpropanesulfonic acid, (meth)acrylamidepropanesulfonic acid, sulfopropyl(meth)acrylate, and (meth)acryloyloxynaphthalenesulfonic acid; phosphoric acid group containing monomers such as 2-hydroxyethylacryloyl phosphate; acrylamide; and acrylonitrile. These copolymerizable monomer components may be used alone or in combination of two or more thereof. The amount of the copolymerizable monomer(s) to be used is preferably 40% or less by weight of all the monomer components.

For crosslinking, the acrylic polymer can also contain multifunctional monomers if necessary as the copolymerizable monomer component. Such multifunctional monomers include hexane diol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylol propane tri(meth)acrylate, pentaerythritol tri(meth)acrylate, dipentaerythritol hexa(meth)acrylate, epoxy(meth)acrylate, polyester(meth)acrylate, urethane(meth)acrylate etc. These multifunctional monomers can also be used as a mixture of one or more thereof. From the viewpoint of adhesiveness etc., the use amount of the multifunctional monomer is preferably 30 wt % or less based on the whole monomer components.

Preparation of the above acryl polymer can be performed by applying an appropriate manner such as a solution polymerization manner, an emulsion polymerization manner, a bulk polymerization manner, and a suspension polymerization manner to a mixture of one or two or more kinds of component monomers for example. Since the pressure-sensitive adhesive layer preferably has a composition in which the content of low molecular weight materials is suppressed from the viewpoint of prevention of wafer contamination, and since those in which an acryl polymer having a weight average molecular weight of 300000 or more, particularly 400000 to 30000000 is as a main component are preferable from such viewpoint, the pressure-sensitive adhesive can be made to be an appropriate cross-linking type with an internal cross-linking manner, an external cross-linking manner, etc.

An external crosslinking agent can be appropriately adopted in the pressure-sensitive adhesive to increase the weight average molecular weight of the acrylic polymer or the like that is the base polymer. Specific examples of an external crosslinking method include a method of adding a so-called crosslinking agent such as a polyisocyanate compound, an epoxy compound, an aziridine compound, or a melamine crosslinking agent and reacting the product. When the external crosslinking agent is used, the used amount is appropriately determined by a balance with the base polymer to be crosslinked and further by the use as the pressure-sensitive adhesive. Generally, it is about 5 parts by weight or less, and preferably 0.1 to 5 parts by weight to 100 parts by weight of the base polymer. Further, conventionally known various additives such as a tackifier and an antioxidant may be used in the pressure-sensitive adhesive other than the above-described components as necessary.

The pressure-sensitive adhesive layer 2 can be formed with a radiation curing-type pressure-sensitive adhesive. The adhesive strength of the radiation curing-type pressure-sensitive adhesive can be reduced easily by increasing the degree of crosslinking by irradiation with an ultraviolet ray or the like, and a difference in the adhesive strength with the portion 2b may be created by irradiating with an ultraviolet ray only the portion 2a that corresponds to the semiconductor wafer pasting portion of the pressure-sensitive adhesive layer 2 shown in FIG. 2.

The portion 2a where the adhesive strength is remarkably reduced can be easily formed by curing the radiation curing-type pressure-sensitive adhesive layer 2 in accordance with the adhesive layer 3′ shown in FIG. 2. Because the adhesive layer 3′ is pasted onto the portion 2a where the adhesive strength is reduced by curing, the interface between the portion 2a in the pressure-sensitive adhesive layer 2 and the adhesive layer 3′ has a characteristic of peeling easily during pickup. On the other hand, the portion that is not irradiated with radiation has sufficient adhesive strength and forms the portion 2b.

As described above, the portion 2b that is formed with an uncured radiation curing-type pressure-sensitive adhesive adheres to the adhesive layer 3, and the holding power can be secured during dicing in the pressure-sensitive adhesive layer 2 of the adhesive film with a dicing sheet 10 shown in FIG. 1. In this manner, the radiation curing-type pressure-sensitive adhesive can support the adhesive layer 3 for fixing the semiconductor chip (the semiconductor chip and the like) onto an adherend such as a substrate with a good balance of adhesion and peeling. In the pressure-sensitive adhesive layer 2 of the adhesive film with a dicing sheet 11 shown in FIG. 2, the portion 2b can fix a wafer ring.

As the radiation curing-type pressure-sensitive adhesive, those having a radiation curable functional group such as a carbon-carbon double bond and having adherability can be used without particular limitation. An example of the radiation curing-type pressure-sensitive adhesive is an adding-type radiation curing-type pressure-sensitive adhesive in which a radiation curable monomer or oligomer component is incorporated into a general pressure-sensitive adhesive such as the acrylic pressure-sensitive adhesive or the rubber pressure-sensitive adhesive.

Examples of the radiation curing-type monomer component to be compounded include such as an urethane oligomer, urethane(meth)acrylate, trimethylolpropane tri(meth)acrylate, tetramethylolmethane tetra(meth)acrylate, pentaerythritol tri(meth)acrylate, pentaerythritol tetra(meth)acrylate, dipentaerythritol monohydroxypenta(meth)acrylate, dipentaerythritol hexa(meth)acrylate, and 1,4-butane dioldi(meth)acrylate. Further, the radiation curing-type oligomer component includes various types of oligomers such as an urethane based, a polyether based, a polyester based, a polycarbonate based, and a polybutadiene based oligomer, and its molecular weight is appropriately in a range of about 100 to 30,000. The compounding amount of the radiation curing-type monomer component and the oligomer component can be appropriately determined to an amount in which the adhesive strength of the pressure-sensitive adhesive layer can be decreased depending on the type of the pressure-sensitive adhesive layer. Generally, it is for example 5 to 500 parts by weight, and preferably about 40 to 150 parts by weight based on 100 parts by weight of the base polymer such as an acryl polymer constituting the pressure sensitive adhesive.

Further, besides the added type radiation curing-type pressure-sensitive adhesive described above, the radiation curing-type pressure-sensitive adhesive includes an internal radiation curing-type pressure-sensitive adhesive using an acryl polymer having a radical reactive carbon-carbon double bond in the polymer side chain, in the main chain, or at the end of the main chain as the base polymer. The internal radiation curing-type pressure-sensitive adhesives of an internally provided type are preferable because they do not have to contain the oligomer component, etc. that is a low molecular weight component, or most of them do not contain, they can form a pressure-sensitive adhesive layer having a stable layer structure without migrating the oligomer component, etc. in the pressure sensitive adhesive over time.

The above-mentioned base polymer, which has a carbon-carbon double bond, may be any polymer that has a carbon-carbon double bond and further has viscosity. As such a base polymer, a polymer having an acrylic polymer as a basic skeleton is preferable. Examples of the basic skeleton of the acrylic polymer include the acrylic polymers exemplified above.

The method for introducing a carbon-carbon double bond into any one of the above-mentioned acrylic polymers is not particularly limited, and may be selected from various methods. The introduction of the carbon-carbon double bond into a side chain of the polymer is easier in molecule design. The method is, for example, a method of copolymerizing a monomer having a functional group with an acrylic polymer, and then causing the resultant to condensation-react or addition-react with a compound having a functional group reactive with the above-mentioned functional group and a carbon-carbon double bond while keeping the radiation curability of the carbon-carbon double bond.

Examples of the combination of these functional groups include a carboxylic acid group and an epoxy group; a carboxylic acid group and an aziridine group; and a hydroxyl group and an isocyanate group. Of these combinations, the combination of a hydroxyl group and an isocyanate group is preferable from the viewpoint of the easiness of reaction tracing. If the above-mentioned acrylic polymer, which has a carbon-carbon double bond, can be produced by the combination of these functional groups, each of the functional groups maybe present on any one of the acrylic polymer and the above-mentioned compound. It is preferable for the above-mentioned preferable combination that the acrylic polymer has the hydroxyl group and the above-mentioned compound has the isocyanate group. Examples of the isocyanate compound in this case, which has a carbon-carbon double bond, include methacryloyl isocyanate, 2-methacryloyloxyethyl isocyanate, and m-isopropenyl-α,α-dimethylbenzyl isocyanate. The used acrylic polymer may be an acrylic polymer copolymerized with any one of the hydroxyl-containing monomers exemplified above, or an ether compound such as 2-hydroxyethyl vinyl ether, 4-hydroxybutyl vinyl ether or diethylene glycol monovinyl ether.

The intrinsic type radiation curable adhesive may be made only of the above-mentioned base polymer (in particular, the acrylic polymer), which has a carbon-carbon double bond. However, the above-mentioned radiation curable monomer component or oligomer component may be incorporated into the base polymer to such an extent that properties of the adhesive are not deteriorated. The amount of the radiation curable oligomer component or the like is usually 30 parts or less by weight, preferably from 0 to 10 parts by weight for 100 parts by weight of the base polymer.

The radiation curing-type pressure-sensitive adhesive preferably contains a photopolymerization initiator in the case of curing it with an ultraviolet ray or the like Examples of the photopolymerization initiator include α-ketol compounds such as 4-(2-hydroxyethoxy)phenyl(2-hydroxy-2-propyl)ketone, α-hydroxy-α,α′-dimethylacetophenone, 2-methyl-2-hydroxypropiophenone, and 1-hydroxycyclohexyl phenyl ketone; acetophenone compounds such as methoxyacetophenone, 2,2-dimethoxy-2-phenylacetophenone, 2,2-diethoxyacetophenone, and 2-methyl-1-[4-(methylthio)-phenyl]-2-morpholinopropane-1; benzoin ether compounds such as benzoin ethyl ether, benzoin isopropyl ether, and anisoin methyl ether; ketal compounds such as benzyl dimethyl ketal; aromatic sulfonyl chloride compounds such as 2-naphthalenesulfonyl chloride; optically active oxime compounds such as 1-phenone-1,1-propanedione-2-(o-ethoxycarbonyl)oxime; benzophenone compounds such as benzophenone, benzoylbenzoic acid, and 3,3′-dimethyl-4-methoxybenzophenone; thioxanthone compound such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, and 2,4-diisopropylthioxanthone; camphorquinone; halogenated ketones; acylphosphonoxides; and acylphosphonates. The amount of the photopolymerization initiator to be blended is, for example, from about 0.05 to 20 parts by weight for 100 parts by weight of the acrylic polymer or the like which constitutes the adhesive as a base polymer.

Further, examples of the radiation curing-type pressure-sensitive adhesive which is used in the formation of the pressure-sensitive adhesive layer 2 include such as a rubber pressure-sensitive adhesive or an acryl pressure-sensitive adhesive which contains an addition-polymerizable compound having two or more unsaturated bonds, a photopolymerizable compound such as alkoxysilane having an epoxy group, and a photopolymerization initiator such as a carbonyl compound, an organic sulfur compound, a peroxide, an amine, and an onium salt compound, which are disclosed in JP-A No. 60-196956. Examples of the above addition-polymerizable compound having two or more unsaturated bonds include such as polyvalent alcohol ester or oligoester of acryl acid or methacrylic acid and an epoxy or a urethane compound.

The radiation curing-type pressure-sensitive adhesive layer 2 can contain a compound that is colored by radiation irradiation as necessary. By containing the compound that is colored by radiation irradiation in the pressure-sensitive adhesive layer 2, only a portion irradiated with radiation can be colored. That is, the portion 2a that corresponds to the semiconductor wafer pasting portion 3a shown in FIG. 1 can be colored. Therefore, whether the pressure-sensitive adhesive layer 2 is irradiated with radiation or not can be visually determined right away, and the semiconductor wafer pasting portion 3a can be recognized easily, and the pasting of the semiconductor wafer is easy. Further, when detecting a semiconductor element with a photosensor or the like, the detection accuracy improves, and no false operation occurs during pickup of the semiconductor element.

The compound that colors by radiation irradiation is colorless or has a pale color before the irradiation. However, it is colored by irradiation with radiation. A preferred specific example of the compound is a leuco dye. Common leuco dyes such as triphenylmethane, fluoran, phenothiazine, auramine, and spiropyran dyes can be preferably used. Specific examples thereof include 3-[N-(p-tolylamino)]-7-anilinofluoran, 3-[N-(p-tolyl)-N-methylamino]-7-anilinofluoran, 3-[N-(p-tolyl)-N-ethylamino]-7-anilinofluoran, 3-diethylamino-6-methyl-7-anilinofluoran, crystal violet lactone, 4,4′,4″-trisdimethylaminotriphenylmethanol, and 4,4′,4″-trisdimethylaminotriphenylmethane.

Examples of a developer that is preferably used with these leuco dyes include a prepolymer of a conventionally known phenolformalin resin, an aromatic carboxylic acid derivative, and an electron acceptor such as activated white earth, and various color developers can be used in combination for changing the color tone.

The compound that colors by irradiation with radiation may be included in the radiation curing-type pressure-sensitive adhesive after being dissolved in an organic solvent or the like, or may be included in the pressure-sensitive adhesive in the form of a fine powder. The ratio of use of this compound is 10% by weight or less, preferably 0.01 to 10% by weight, and more preferably 0.5 to 5% by weight in the pressure-sensitive adhesive layer 2. When the ratio of the compound exceeds 10% by weight, the curing of the portion 2a of the pressure-sensitive adhesive layer 2 becomes insufficient because the radiation onto the pressure-sensitive adhesive layer 2 is absorbed too much by this compound, and the adhesive strength may not reduce sufficiently. On the other hand, the ratio of the compound is preferably 0.01% by weight or more to color the compound sufficiently.

When forming the pressure-sensitive adhesive layer 2 with the radiation curing-type pressure-sensitive adhesive, part of the pressure-sensitive adhesive layer 2 may be irradiated with radiation so that the adhesive strength of the portion 2a in the pressure-sensitive adhesive layer 2 becomes less than the adhesive strength of the portion 2b.

An example of the method of forming the portion 2a on the pressure-sensitive adhesive layer 2 is a method of forming the radiation curing-type pressure-sensitive adhesive layer 2 on the base material 1 and then curing the layer by irradiating the portion 2a partially with radiation. The partial irradiation with radiation can be performed through a photo mask that has a pattern corresponding to the portion 3b or the like other than the semiconductor wafer pasting portion 3a. Another example is a method of curing the layer by irradiation with an ultraviolet ray in spots. The formation of the radiation curing-type pressure-sensitive adhesive layer 2 can be performed by transferring a layer provided on a separator onto the base material 1. The partial radiation curing can also be performed on the radiation curing-type pressure-sensitive adhesive layer 2 that is provided on the separator.

Further, when forming the pressure-sensitive adhesive layer 2 with a radiation curing-type pressure-sensitive adhesive, the portion 2a having a reduced adhesive strength can be formed by using at least one surface of the base material 1 where the whole or part of the portion other than the portion corresponding to the semiconductor wafer pasting portion 3a is protected from light, forming the radiation curing-type pressure-sensitive adhesive layer 2 on this surface, and curing the portion corresponding to the semiconductor wafer pasting portion 3a by irradiation with radiation. As a light-shielding material, a material that is capable of serving as a photo mask on a supporting film can be produced by printing, vapor deposition, or the like. According to such a manufacturing method, the adhesive film with a dicing sheet 10 of the present invention can be efficiently manufactured.

When curing is inhibited due to oxygen during irradiation with radiation, it is desirable to shield oxygen (air) from the surface of the radiation curing-type pressure-sensitive adhesive layer 2 in some way. Examples of the method include a method of covering the surface of the pressure-sensitive adhesive layer 2 with a separator and a method of performing irradiation with an ultraviolet ray or the like in a nitrogen gas atmosphere.

The thickness of the pressure-sensitive adhesive layer 2 is not especially limited. However, it is preferably about 1 to 50 μm from the viewpoint of preventing cracking on the cut surface of the chip and maintaining the fixation of the adhesive layer. It is more preferably 2 to 30 μm, and further preferably 5 to 25 μm.

The adhesive layers 3 and 3′ are each a layer having an adhesion function. As the constituents thereof, a thermoplastic resin and a thermosetting resin may be used together, or a thermoplastic resin or a thermosetting resin may be used alone.

The lamination structure of the adhesive layers 3 and 3′ is not especially limited, and examples thereof include a structure consisting of a single layer and a multi-layer structure in which adhesive layer(s) is/are formed on one surface or both surfaces of a core material. Examples of the core material include films (such as polyimide film, polyester film, polyethylene terephthalate film, polyethylene naphthalate film, and polycarbonate film); resin substrates which are reinforced with glass fiber or plastic nonwoven finer; silicon substrates; and glass substrates.

Examples of the thermoplastic resin include natural rubber, butyl rubber, isoprene rubber, chloroprene rubber, ethylene/vinyl acetate copolymer, ethylene/acrylic acid copolymer, ethylene/acrylic ester copolymer, polybutadiene resin, polycarbonate resin, thermoplastic polyimide resin, polyamide resins such as 6-nylon and 6,6-nylon, phenoxy resin, acrylic resin, saturated polyester resins such as PET and PBT, polyamideimide resin, and fluorine-contained resin. These thermoplastic resins may be used alone or in combination of two or more thereof. Of these thermoplastic resins, acrylic resin is particularly preferable since the resin contains ionic impurities in only a small amount and has a high heat resistance so as to make it possible to ensure the reliability of the semiconductor element.

The acrylic resin is not limited to any especial kind, and may be, for example, a polymer comprising, as a component or components, one or more esters of acrylic acid or methacrylic acid having a linear or branched alkyl group having 30 or less carbon atoms, in particular, 4 to 18 carbon atoms. Examples of the alkyl group include methyl, ethyl, propyl, isopropyl, n-butyl, t-butyl, isobutyl, amyl, isoamyl, hexyl, heptyl, cyclohexyl, 2-ethylhexyl, octyl, isooctyl, nonyl, isononyl, decyl, isodecyl, undecyl, lauryl, tridecyl, tetradecyl, stearyl, octadecyl, and dodecyl groups.

A different monomer which constitutes the above-mentioned polymer is not limited to any especial kind, and examples thereof include carboxyl-containing monomers such as acrylic acid, methacrylic acid, carboxyethyl acrylate, carboxypentyl acrylate, itaconic acid, maleic acid, fumaric acid, and crotonic acid; acid anhydride monomers such as maleic anhydride and itaconic anhydride; hydroxyl-containing monomers such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxymethylcyclohexyl)methylacrylate; monomers which contain a sulfonic acid group, such as styrenesulfonic acid, allylsulfonic acid, 2-(meth)acrylamide-2-methylpropanesulfonic acid, (meth)acrylamidepropane sulfonic acid, sulfopropyl(meth)acrylate, and (meth)acryloyloxynaphthalenesulfonic acid; and monomers which contain a phosphoric acid group, such as 2-hydroxyethylacryloyl phosphate.

Examples of the above-mentioned thermosetting resin include phenol resin, amino resin, unsaturated polyester resin, epoxy resin, polyurethane resin, silicone resin, and thermosetting polyimide resin. These resins may be used alone or in combination of two or more thereof. Particularly preferable is epoxy resin, which contains ionic impurities which corrode semiconductor elements in only a small amount. As the curing agent of the epoxy resin, phenol resin is preferable.

The epoxy resin may be any epoxy resin that is ordinarily used as an adhesive composition. Examples thereof include bifunctional or polyfunctional epoxy resins such as bisphenol A type, bisphenol F type, bisphenol S type, brominated bisphenol A type, hydrogenated bisphenol A type, bisphenol AF type, biphenyl type, naphthalene type, fluorene type, phenol Novolak type, orthocresol Novolak type, tris-hydroxyphenylmethane type, and tetraphenylolethane type epoxy resins; hydantoin type epoxy resins; tris-glycicylisocyanurate type epoxy resins; and glycidylamine type epoxy resins. These may be used alone or in combination of two or more thereof. Among these epoxy resins, particularly preferable are Novolak type epoxy resin, biphenyl type epoxy resin, tris-hydroxyphenylmethane type epoxy resin, and tetraphenylolethane type epoxy resin, since these epoxy resins are rich in reactivity with phenol resin as an agent for curing the epoxy resin and are superior in heat resistance and so on.

The phenol resin is a resin acting as a curing agent for the epoxy resin. Examples thereof include Novolak type phenol resins such as phenol Novolak resin, phenol aralkyl resin, cresol Novolak resin, tert-butylphenol Novolak resin and nonylphenol Novolak resin; resol type phenol resins; and polyoxystyrenes such as poly(p-oxystyrene). These may be used alone or in combination of two or more thereof. Among these phenol resins, phenol Novolak resin and phenol aralkyl resin are particularly preferable, since the connection reliability of the semiconductor device can be improved.

About the blend ratio between the epoxy resin and the phenol resin, for example, the phenol resin is blended with the epoxy resin in such a manner that the hydroxyl groups in the phenol resin is preferably from 0.5 to 2.0 equivalents, more preferably from 0.8 to 1.2 equivalents per equivalent of the epoxy groups in the epoxy resin component. If the blend ratio between the two is out of the range, curing reaction therebetween does not advance sufficiently so that properties of the cured epoxy resin easily deteriorate.

In the present invention, adhesive layer comprising the epoxy resin, the phenol resin, and an acrylic resin is particularly preferable. Since these resins contain ionic impurities in only a small amount and have high heat resistance, the reliability of the semiconductor element can be ensured. About the blend ratio in this case, the amount of the mixture of the epoxy resin and the phenol resin is from 10 to 200 parts by weight for 100 parts by weight of the acrylic resin component.

The thermal curing accelerator catalyst for the epoxy resin and the phenol resin is not especially limited, and it is appropriately selected from known thermal curing accelerator catalysts. The thermal curing accelerator catalyst can be used alone or two types or more of them can be used in combination. Examples of the thermal curing accelerator catalyst that can be used include an amine curing accelerator, a phosphorus curing accelerator, an imidazole curing accelerator, a boron curing accelerator, and a phosphorus-boron curing accelerator.

The adhesive layers 3 and 3′ may be colored as necessary in the present invention. The color that is provided to the adhesive layers 3 and 3′ by coloring is not especially limited, and preferred examples thereof include black, blue, red, and green. When the adhesive film is used as a die bond film, it is normally not colored (although it may be colored). However, when it is used as a film for a backside of a flip-chip semiconductor, it is normally colored. For coloring, a colorant to be used can be appropriately selected from known colorants such as pigments and dyes.

In order to crosslink the adhesive layer 3, 3′ of the present invention to some extent in advance, it is preferable to add, as a crosslinking agent, a polyfunctional compound which reacts with functional groups of molecular chain terminals of the above-mentioned polymer to the materials used when the sheet 12 is produced. In this way, the adhesive property of the sheet at high temperatures is improved so as to improve the heat resistance.

The crosslinking agent may be one known in the prior art. Particularly preferable are polyisocyanate compounds, such as tolylene diisocyanate, diphenylmethane diisocyanate, p-phenylene diisocyanate, 1,5-naphthalene diisocyanate, and adducts of polyhydric alcohol and diisocyanate. The amount of the crosslinking agent to be added is preferably set to 0.05 to 7 parts by weight for 100 parts by weight of the above-mentioned polymer. If the amount of the crosslinking agent to be added is more than 7 parts by weight, the adhesive force is unfavorably lowered. On the other hand, if the adding amount is less than 0.05 part by weight, the cohesive force is unfavorably insufficient. A different polyfunctional compound, such as an epoxy resin, together with the polyisocyanate compound may be incorporated if necessary.

Further, an inorganic filler can be appropriately incorporated into the adhesive layers 3 and 3′. The incorporation of the inorganic filler gives the surface of the adhesive layers 3 and 3′ unevenness. Further, electric conductivity may be given, thermal conductivity may be improved, and the storage modulus may be adjusted.

Examples of the inorganic fillers include various inorganic powders made of the following: a ceramic such as silica, clay, plaster, calcium carbonate, barium sulfate, aluminum oxide, beryllium oxide, silicon carbide or silicon nitride; a metal such as aluminum, copper, silver, gold, nickel, chromium, lead, tin, zinc, palladium or solder, or an alloy thereof; and carbon. These may be used alone or in combination of two or more thereof. Among these, silica, in particular fused silica is preferably used.

The average particle size of the inorganic filler is preferably within a range of 0.1 to 5 μm, and more preferably within a range of 0.2 to 3 μm. When the average particle size of the inorganic filler is less than 0.1 μm, it becomes difficult to make Ra of the adhesive layer be 0.15 μm or more. On the other hand, when the average particle size exceeds 5 μm, it becomes difficult to make Ra less than 1 μm. In the present invention, two or more types of inorganic fillers having a different average particle size may be used in combination. The value of the average particle size is obtained using a luminous intensity type particle size distribution meter (manufactured by HORIBA, Ltd., device name: LA-910) for example.

The incorporation amount of the inorganic filler is preferably set to 20 to 80 parts by weight to 100 parts weight of the organic resin component. It is especially preferably 20 to 70 parts by weight. When the incorporation amount of the inorganic filler is less than 20 parts by weight, heat resistance deteriorates. Therefore, the adhesive layers 3 and 3′ cure when they are exposed to a thermal history of high temperature for a long time, and fluidity and the embedding property may deteriorate. When it exceeds 80 parts by weight, the storage modulus of the adhesive layers 3 and 3′ becomes large. Accordingly, it becomes difficult for the cured adhesive to relax the stress, and the embedding property into an uneven surface may deteriorate in a sealing step.

If necessary, other additives besides the inorganic filler may be incorporated into the adhesive layer 3, 3′ of the present invention. Examples thereof include a flame retardant, a silane coupling agent, and an ion trapping agent. Examples of the flame retardant include antimony trioxide, antimony pentaoxide, and brominated epoxy resin. These maybe used alone or in combination of two or more thereof. Examples of the silane coupling agent include β-(3,4-epoxycyclohexyl)ethyltrimethoxysilane, γ-glycidoxypropyltrimethoxysilane, and γ-glycidoxypropylmethyldiethoxysilane. These may be used alone or in combination of two or more thereof. Examples of the ion trapping agent include hydrotalcite and bismuth hydroxide. These maybe used alone or in combination of two or more thereof.

The thickness of the adhesive layer 3, 3′ (in the case that the film is a laminate, the total thickness thereof) is not particularly limited, and is, for example, from about 5 to 100 μm, preferably from about 5 to 50 μm.

The adhesive layers 3, 3′ of the adhesive film with a dicing sheets 10, 11 are preferably protected by a separator (not shown). The separator has a function as a protecting material that protects the adhesive layers 3, 3′ until they are practically used. Further, the separator can be used as a supporting base material when transferring the adhesive layers 3, 3′ to the pressure-sensitive adhesive layer 2. The separator is peeled when pasting a workpiece onto the adhesive layers 3, 3′ of the adhesive film with a dicing sheet. Polyethylenetelephthalate (PET), polyethylene, polypropylene, a plastic film, a paper, etc. whose surface is coated with a peeling agent such as a fluorine based peeling agent and a long chain alkylacrylate based peeling agent can be also used as the separator.

(Method of Manufacturing Adhesive Film with Dicing Sheet)

A method of manufacturing the adhesive film with a dicing sheet according to the present embodiment includes the steps of forming the pressure-sensitive adhesive layer 2 on the base material 1, modifying the surface of the pressure-sensitive adhesive layer 2, and forming the adhesive layer 3 on the pressure-sensitive adhesive layer 2 after the surface modification.

Examples of a method of forming the base material 1 include a calender film forming method, a casting method in an organic solvent, an inflation extrusion method in a closed system, a T die extrusion method, a coextrusion method, and a dry lamination method.

The pressure-sensitive adhesive layer 2 can be formed by applying a solution of a pressure-sensitive adhesive composition onto the base material 1 and drying the solution under a prescribed condition (heat cross-linking the solution as necessary). The application method is not especially limited, and examples thereof include roll coating, screen coating, and gravure coating. The application thickness is appropriately set so that the thickness of the pressure-sensitive adhesive layer 2 that can be eventually obtained by drying the coating layer falls within a range of 1 to 50 μm. The viscosity of the pressure-sensitive adhesive composition solution is not especially limited. However, it is preferably 100 to 5000 mPa·s, and more preferably 200 to 3000 mPa·s.

The method of drying the coating layer is not especially limited. However, it is preferably dried without using a dry wind when forming a pressure-sensitive adhesive layer having a flat surface, for example. The drying time can be appropriately set according to the application amount of the pressure-sensitive adhesive composition solution; it is normally within a range of 0.5 to 5 min, and preferably within a range of 2 to 4 min. The drying temperature is not especially limited; it is normally 80 to 150° C., and preferably 80 to 130° C.

The pressure-sensitive adhesive layer 2 maybe formed by forming a coating film of a pressure-sensitive adhesive composition by application on a separator, and then drying the coating film under the above-described drying condition. Then, the pressure-sensitive adhesive layer 2 is transferred onto the base material.

Next, the surface of the pressure-sensitive adhesive layer 2 is modified. In this step, the surface modification is performed at least on the surface that is planned to be pasted with the adhesive layer 3. The method of the surface modification is not especially limited. However, a method of spraying a solution containing at least a silicone resin in mist form, a method of performing the surface modification by transferring a film to which a silicone resin is applied onto another film, and a method of performing the surface modification by applying a silicone dispersion onto the surface of the pressure-sensitive adhesive layer and drying the dispersion are preferable, for example. When spraying a solution containing a silicone resin in mist form, the spraying amount is appropriately set according to the area of the region on which the surface modification is performed. However, by adjusting the speed, height, and discharge amount of the spraying, the surface of the region that is sprayed with the solution is preferably modified so that the intensity of an Si—Kα ray in the region falls within a range of 0.01 to 100 kcps.

An example of the step of forming the adhesive layer 3 is a method of performing the steps of forming a coating layer by applying an adhesive composition solution onto a releasing film and then drying the coating layer.

The method of applying the adhesive composition solution is not especially limited. However, an example is a method of applying the solution using a comma coating method, a fountain method, a gravure method, or the like. The application thickness is appropriately set so that the thickness of the adhesive layer that can be eventually obtained by drying the coating layer falls within a range of 5 to 100 μm. The viscosity of the adhesive composition solution is not especially limited. However, it is preferably 400 to 2500 mPa·s, and more preferably 800 to 2000 mPa·s.

The releasing film is not especially limited. However, an example thereof is a film in which a release coating layer such as a silicone layer is formed on the surface of the releasing film which is pasted onto the adhesive layer on the base material. Examples of the base material of the releasing film include paper such as glassine paper and a resin film made of polyethylene, polypropylene, or polyester.

The drying of the coating layer is performed by blowing a dry wind over the coating layer. Examples of the method of blowing a dry wind include a method of blowing a dry wind so that the direction of blowing becomes parallel to the direction of transporting the releasing film and a method of blowing a dry wind so that the direction of blowing becomes perpendicular to the surface of the coating layer. The flow of the dry wind is not especially limited, and it is normally 5 to 20 m/min, and preferably 5 to 15 m/min. With the flow of the dry wind being 5 m/min or more, the drying of the coating layer is prevented from becoming insufficient. On the other hand, with the flow of the dry wind being 20 m/min or less, the concentration of the organic solvent in the vicinity of the surface of the coating layer becomes uniform, and therefore, evaporation of the solvent can be made uniform. As a result, an adhesive layer having a uniform surface can be formed.

The drying time is appropriately set according to the applied thickness of the adhesive composition solution; it is normally within a range of 1 to 5 min, and preferably within a range of 2 to 4 min. When the drying time is less than 1 min, the curing reaction does not proceed sufficiently, and the amount of unreacted curing component and the amount of the remained solvent becomes large. Accordingly, problems of outgassing and voids may occur in the subsequent steps. On the other hand, when it exceeds 5 min, the curing reaction proceeds too much. As a result, fluidity and the embedding property to the adherend may deteriorate.

The drying temperature is not especially limited, and it is normally set within a range of 70 to 160° C. However, the drying temperature is preferably increased stepwise with the passage of the drying time in the present invention. Specifically, it is set within a range of 70 to 100° C. at an initial stage of the drying (1 min or less from immediately after the start of the drying), and it is set within a range of 100 to 160° C. at a late stage of the drying (more than 1 min to 5 min or less) for example. Accordingly, pin holes on the surface of the coating layer that generate when the drying temperature is rapidly increased right after the start of the coating can be prevented. As a result, the adhesive layer 3 can be formed having an uneven surface and an arithmetic average roughness Ra of 0.015 to 1 μm.

Next, the adhesive layer 3 is transferred onto the pressure-sensitive adhesive layer 2. The transfer is performed by pressure bonding. The pasting temperature is 30 to 50° C., and preferably 35 to 45° C. The pasting pressure is 0.1 to 0.6 MPa, and preferably 0.2 to 0.5 MPa.

The releasing film may be peeled after the adhesive layer 3 is pasted onto the pressure-sensitive adhesive layer 2 or it may be used as a protective film of the adhesive film with a dicing sheet as it is and then peeled when the adhesive film is pasted onto the semiconductor wafer. Accordingly, the adhesive film with a dicing sheet according to the present embodiment can be manufactured.

### (Producing Method of Semiconductor Device)

The adhesive film with a dicing sheets 10, 11 of the present invention are used as follows by appropriately peeling the separator arbitrarily provided on the adhesive layers 3, 3′. Hereinbelow, referring to FIG. 3, it is described while using the dicing die-bonding 11 as an example.

First, a semiconductor wafer 4 is press-adhered on the adhesive layer 3 in the adhesive film with a dicing sheet 10, and it is fixed by adhering and holding (mounting step). The present step is performed while pressing with a pressing means such as a pressing roll. The laminating temperature at the time of mounting is not particularly limited and is, for example, preferably within a range from 20 to 80° C.

Next, the dicing of the semiconductor wafer 4 is performed. Accordingly, the semiconductor wafer 4 is cut into a prescribed size and individualized, and a semiconductor chip 5 is produced. The dicing is performed following a normal method from the circuit face side of the semiconductor wafer 4, for example. Further, the present step can adopt such as a cutting method called full-cut that forms a slit in the adhesive film with a dicing sheet 10. The dicing apparatus used in the present step is not particularly limited, and a conventionally known apparatus can be used. Further, because the semiconductor wafer 4 is adhered and fixed by the adhesive film with a dicing sheet 10, chip crack and chip fly can be suppressed, and at the same time the damage of the semiconductor wafer can be also suppressed.

Pickup of the semiconductor chip 5 is performed in order to peel a semiconductor chip 5 that is adhered and fixed to the adhesive film with a dicing sheet 10. The method of picking up is not particularly limited. Examples include a method of pushing up the individual semiconductor chip 5 from the dicing die-bonding 10 side with a needle and picking up the pushed semiconductor chip 5 with a picking-up apparatus.

Here, the picking up is performed after radiating the pressure-sensitive adhesive layer 2 with ultraviolet rays because the pressure-sensitive adhesive layer 2 is an ultraviolet curing-type pressure-sensitive adhesive layer. Accordingly, the adhesive strength of the pressure-sensitive adhesive layer 2 to the adhesive layer 3 decreases, and the peeling of the semiconductor chip 5 becomes easy. As a result, picking up becomes possible without damaging the semiconductor chip 5. The condition such as irradiation intensity and irradiation time when irradiating an ultraviolet ray is not particularly limited, and it may be appropriately set depending on necessity. Further, the light source as described above can be used as a light source used in the ultraviolet irradiation.

Next, the semiconductor chip 5 that is formed by dicing is die-bonded to an adherend 6 with the adhesive layer 3 interposed as shown in FIG. 3. The die bonding is performed by pressure bonding. The condition of the die bonding is not especially limited, and can be appropriately set. Specifically, the die bonding can be performed at a die bond temperature of 80 to 160° C., a die bonding pressure of 5 to 15 N, and a bonding time of 1 to 10 seconds, for example.

A conventionally known substrate can be used as the substrate. Further, a metal lead frame such as a Cu lead frame and a 42 Alloy lead frame and an organic substrate composed of glass epoxy, BT (bismaleimide-triazine), and polyimide can be used as the lead frame. However, the present invention is not limited to this, and includes a circuit substrate that can be used by mounting a semiconductor element and electrically connecting with the semiconductor element.

Then, the adhesive layer 3 is thermally cured by performing a heat treatment, and the semiconductor chip 5 is adhered to the adherend 6. The condition of the heat treatment is a temperature of 80 to 180° C. and a heating time of 0.1 to 24 hours, preferably 0.1 to 4 hours, and more preferably 0.1 to 1 hour.

Next, a wire bonding step of electrically connecting the tip of a terminal part (inner lead) of the adherend 6 with an electrode pad (not shown) on the semiconductor chip 5 with a bonding wire 7 is performed. The bonding wires 7 may be, for example, gold wires, aluminum wires, or copper wires. The temperature when the wire bonding is performed is from 80 to 250° C., preferably from 80 to 220° C. The heating time is from several seconds to several minutes. The connection of the wires is performed by using a combination of vibration energy based on ultrasonic waves with compression energy based on the application of pressure in the state that the wires are heated to a temperature in the above-mentioned range.

The adhesive layer 3 after thermosetting preferably has a shear adhering strength of 0.01 MPa or more, and more preferably 0.01 to 5 MPa at 175° C. With the shear adhering strength of 0.01 MPa or more at 175° C. after thermosetting, shear deformation at the adhesion surface of the adhesive layer 3a with the semiconductor chip 5 or the adherend 6 caused by ultrasonic vibration or heating during the wire bonding step can be prevented. That is, the success rate of wire bonding is prevented from decreasing since the semiconductor element does not move due to the ultrasonic vibration during wire bonding.

The wire bonding step may be performed without thermosetting the adhesive layer 3 by a heat treatment. In this case, the shear adhering strength at 25° C. of the adhesive layer 3 to the adherend 6 is preferably 0.2 MPa or more, and more preferably 0.2 to 10 MPa. With the shear adhering strength being 0.2 MPa or more, shear deformation does not occur at the adhesion surface of the adhesive layer 3 with the semiconductor chip 5 or the adherend 6 caused by ultrasonic vibration or heating in this step even when the wire bonding step is performed without thermosetting the adhesive layer 3. That is, the success rate of wire bonding is prevented from decreasing since the semiconductor element does not move due to the ultrasonic vibration during wire bonding.

Further, the uncured adhesive layer 3 does not completely thermoset even when the wire bonding step is performed. The shear adhering strength of the adhesive layer 3 is necessarily 0.2 MPa or more even when the temperature is within a range of 80 to 250° C. When the shear adhering strength is less than 0.2 MPa in this temperature range, the semiconductor element moves due to the ultrasonic vibration during wire bonding and the wire bonding cannot be performed, and therefore the yield decreases.

Then, a sealing step sealing the semiconductor chip 5 with a sealing resin 8 is performed. This step is performed for protecting the semiconductor chip 5 that is loaded on the adherend 6 and the bonding wire 7. This step is performed by molding a resin for sealing with a mold. An example of the sealing resin 8 is an epoxy resin. The heating temperature during the resin sealing is normally 175° C. and it is performed for 60 to 90 seconds. However, the present invention is not limited thereto, and the curing can be performed at 165 to 185° C. for a few minutes, for example. With this operation, the sealing resin is cured, and the adhesive layer 3a is also thermally cured when the adhesive layer 3 is not previously thermally cured. That is, in the present invention, even when a post curing step that described later is not performed, the adhesive layer 3 can be thermally cured and adhered in this step and the present invention can contribute to a reduction in the number of manufacturing steps and a reduction in the manufacturing period of the semiconductor device.

The sealing resin 8 that is insufficiently cured in the sealing step is completely cured in the post curing step. Even when the adhesive layer 3 is not thermally cured in the sealing step, the adhesive layer 3 is thermally cured together with the sealing resin 8 to be adhered and fixed in this step. The heating temperature in this step differs depending on the type of the sealing resin. However, it is within a range of 165 to 185° C., for example, and the heating time is about 0.5 to 8 hours.

Further, the adhesive film with a dicing sheet of the present invention can be preferably used when three-dimensionally mounting a plurality of semiconductor chips by lamination as shown in FIG. 4. FIG. 4 is a schematic sectional drawing showing an example of three-dimensionally mounting a semiconductor chip with an adhesive layer interposed. In the case of three-dimensional mounting as shown in FIG. 4, at least one adhesive layer 3 that is cut out so that it has the same size as the semiconductor chip is pasted onto the adherend 6 first, and then the semiconductor chip 5 is die-bonded with the adhesive layer 3 interposed so that its wire bonding surface faces upward. Next, an adhesive layer 13 is pasted by avoiding the electrode pad part of the semiconductor chip 5. Further, another semiconductor chip 15 is die-bonded on the adhesive layer 13 so that its wire bonding surface faces upward. After that, the adhesive layers 3 and 13 are thermally cured to adhere and fix by heating, and the heat resistant strength is improved. The heating condition is preferably a temperature of 80 to 200° C. and a heating time of 0.1 to 24 hours, similarly to the above.

Further, the adhesive layers 3 and 13 may only be die-bonded without thermosetting in the present invention. After that, wire bonding can be performed without going through the heating step, the semiconductor chip can be sealed with a sealing resin, and the sealing resin can be after-cured.

Next, the wire bonding step is performed. With this operation, each electrode pad in the semiconductor chip 5 and the different semiconductor chip 15 is electrically connected with the adherend 6 with the bonding wires 7. This step is performed without going through the heating step of the adhesive layers 3a and 13.

Then, the sealing step of sealing the semiconductor chip 5 or the like with the sealing resin 8 is performed, and the sealing resin is cured. At the same time, the adherend 6 and the semiconductor chip 5 are adhered and fixed to each other by thermosetting the adhesive layer 3 when the thermosetting is not performed. The semiconductor chip 5 and the different semiconductor chip 15 are also adhered and fixed to each other by thermosetting the adhesive layer 13. After the sealing step, the post curing step may be performed.

In the case of the three-dimensional mounting of the semiconductor chips, the production process is simplified and the yield is improved since heating treatment by heating the adhesive layers 3 and 13 is not conducted. Furthermore, the adherend 6 is not warped, and the semiconductor chips 5 and 15 are not cracked; thus, the semiconductor element can be made still thinner.

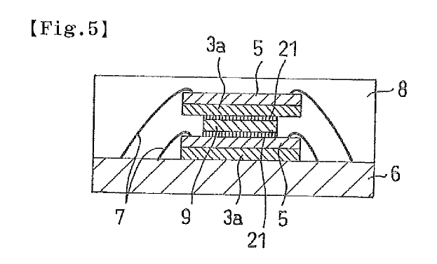

Three-dimensional mounting may performed in which semiconductor chips are laminated through adhesive films so as to interpose a spacer between the semiconductor chips, as illustrated in FIG. 5. FIG. 5 is a schematic sectional view illustrating an example wherein two semiconductor chips are three-dimensionally mounted through adhesive layers so as to interpose a spacer between the chips.

In the case of the three-dimensional mounting illustrated in FIG. 5, first, an adhesive layer 3, a semiconductor chip 5, and an adhesive layer 21 are successively laminated on the adherend 6 to bond these members. Furthermore, on the adhesive layer 21 are successively laminated a spacer 9, another adhesive layer 21, another adhesive layer 3, and another semiconductor chip 5 to bond these members. After that, the adhesive layers 3 and 21 are thermally cured to adhere and fix to each other by heating, whereby the heat resistant strength is improved. The heating condition is preferably at a temperature of 80 to 200° C. and a heating time of 0.1 to 24 hours, similarly to the above.

Further, the adhesive layers 3 and 21 may only be die-bonded without being thermoset in the present invention. After that, the wire bonding can be performed without going through the heating step, the semiconductor chip can be sealed with a sealing resin, and the sealing resin can be after-cured.

Next, as illustrated in FIG. 5, a wire bonding step is performed. In this way, electrode pads on the semiconductor chips 5 are electrically connected with the adherend 6 through bonding wires 7. This step is performed without going through the heating step of the adhesive layers 3 and 21.

Then, the sealing step of sealing the semiconductor chip 5 with the sealing resin 8 is performed. The adherend 6 and the semiconductor chip 5 as well as the semiconductor chip 5 and a spacer 9 are adhered and fixed to each other by thermosetting these when the adhesive layers 3 and 21 are uncured. In this way, a semiconductor package is obtained. The sealing step is preferably performed by a package sealing method wherein only the semiconductor chip 5 is sealed. The sealing is performed to protect the semiconductor chips 5 adhered onto the adhesive sheet(s). The method therefor is typically a method of using the sealing resin 8 and molding the resin 8 in a metal mold. At this time, it is general to use a metal mold composed of an upper metal mold part and a lower metal mold part and having plural cavities to seal simultaneously. The heating temperature at the time of the sealing preferably ranges, for example, from 170 to 180° C. After the sealing step, an after-curing step may be performed.

The spacer 9 is not particularly limited, for example, a silicon chip or polyimide film and the like known in the prior art. The spacer may be a core member. The core member is not particularly limited, and may be a core member known in the prior art. Specific examples thereof include films (such as a polyimide film, a polyester film, a polyethylene terephthalate film, a polyethylene naphthalate film, a polycarbonate film and the like), resin substrates each reinforced with glass fiber or plastic nonwoven fiber, mirror silicon wafers, silicon substrates, and glass substrates.

### (Another Method of Manufacturing Semiconductor Device)

Next, a method of manufacturing a semiconductor device according to another embodiment of the present invention is explained in the following.

In the different method of manufacturing a semiconductor device, a flip-chip-mounted semiconductor device can be manufactured using the adhesive film with a dicing sheet. Specifically, the method includes at least the steps of pasting a semiconductor wafer onto the adhesive film with a dicing sheet, dicing the semiconductor wafer, picking up a semiconductor element that is obtained by dicing, and flip-chip-connecting the semiconductor element onto an adherend.

### [Mounting Step]

First, a separator that is arbitrarily provided on the adhesive film part of the adhesive film with a dicing sheet is appropriately peeled, and a semiconductor wafer is pasted and fixed onto the adhesive film (a mounting step). At this time, the adhesive film is in an uncured state (including a semicured state). The adhesive film with a dicing sheet is pasted onto the backside of the semiconductor wafer. The backside of the semiconductor wafer means the surface opposite to the circuit surface (it is also referred to as a non-circuit surface, a non-electrode surface, or the like) The pasting method is not especially limited, however, a method by pressure bonding is preferable. The pressure bonding is usually performed by a pressing means such as a pressure bonding roll.

### [Dicing Step]

Next, dicing of the semiconductor wafer is performed. With this operation, a semiconductor chip is manufactured by cutting and individualizing (making into small pieces) the semiconductor wafer into a prescribed size. The dicing is performed by an ordinary method from the circuit surface side of the semiconductor wafer, for example. In this step, a cutting method so-called full-cut of cutting the wafer to the adhesive film with a dicing sheet can be adopted, for example. The dicing apparatus that is used in this step is not especially limited, and a conventionally known apparatus can be used. Further, because the semiconductor wafer is adhered and fixed with excellent adhesion by the adhesive film with a dicing sheet having an adhesive film, chip cracking and chip fly can be suppressed and damages to the semiconductor wafer can be suppressed. Moreover, when the adhesive film is formed of a resin composition containing an epoxy resin, the adhesive layer of the adhesive film is restrained or prevented from sticking out at the cut surface when it is cut by dicing. As a result, reattaching (blocking) of two cut surfaces is suppressed or prevented, and the pickup described later can be performed better.

Expanding of the adhesive film with a dicing sheet can be performed using a conventionally known expanding apparatus. The expanding apparatus has a donut-shaped outer ring that can push down the adhesive film with a dicing sheet through a dicing ring and an inner ring having a smaller diameter than the outer ring that supports the adhesive film with a dicing sheet. With this expanding step, two adjacent semiconductor chips can be prevented from contacting to each other and damaged in the pickup step to be described later.

### [Pickup Step]

The semiconductor chip is picked up and peeled together with the adhesive film from the dicing tape to collect the semiconductor chip that is adhered and fixed to the adhesive film with a dicing sheet. The method of picking up is not especially limited, and various conventionally known methods can be adopted. Examples thereof include a method of pushing up the individual semiconductor chip from the side of the base material of the adhesive film with a dicing sheet and picking up the pushed semiconductor chip with a pickup apparatus. The backside of the semiconductor chip that is picked up is protected by the adhesive film.

### [Flip-Chip-Connection Step]

The semiconductor chip that is picked up is fixed to the adherend such as a substrate by a flip-chip-bonding system (a flip-chip-mounting method). Specifically, the semiconductor chip is fixed to the adherend by an ordinary method in a state where the circuit surface (also referred to as a surface, a circuit pattern forming surface, an electrode forming surface, or the like) of the semiconductor chip faces the adherend. For example, the semiconductor chip can be fixed to the adherend by securing electric conduction of the semiconductor chip with the adherent by making a bump that is formed on the circuit surface side of the semiconductor chip contact to a conductive material such as solder that is applied onto the connection pad of the adherend and melting the conductive material while pressing (a flip-chip-bonding step). At this time, a space is formed between the semiconductor chip and the adherend, and the size of the space is generally about 30 to 300 μm. After flip-chip-bonding (flip-chip-connection) of the semiconductor chip onto the adherend, it is important to wash the surface where the semiconductor chip and the adherend face each other and to seal the space by filling the space with a sealing material such as a sealing resin.

Various substrates such as a lead frame and a circuit board such as a wiring circuit board can be used as the adherend. The material of the substrate is not especially limited. However, examples thereof include a ceramic substrate and a plastic substrate. Examples of the plastic substrate include an epoxy substrate, a bismaleimide triazine substrate, and a polyimide substrate.

The material of the bump and the conductive material in the flip-chip-bonding step are not especially limited, and examples thereof include solder (alloys) such as a tin-lead metal material, a tin-silver metal material, a tin-silver-copper metal material, a tin-zinc metal material, and a tin-zinc-bismuth metal material, a gold metal material and a copper metal material.

In the flip-chip-bonding step, the conductive material is melted, and the bump on the circuit surface side of the semiconductor chip 5 and the conductive material on the surface of the adherend 6 are connected to each other. The temperature of melting the conductive material is normally about 260° C. (for example, 250 to 300° C.). The adhesive film with a dicing sheet of the present invention has heat resistance that can withstand a high temperature in the flip-chip-bonding step by being formed of an epoxy resin or the like.

The surface at which the semiconductor chip and the adherend face each other (electrode forming surface) and the space are preferably washed in this step. The washing liquid that is used in washing is not especially limited, and examples thereof include an organic washing liquid and an aqueous washing liquid. The adhesive film part of the adhesive film with a dicing sheet of the present invention has solvent resistance to the washing liquid, and does not substantially exhibit solubility in these washing liquids. Accordingly, various washing liquids can be used as described above, and the adhesive film can be washed by a conventional method without requiring a special washing liquid.

Next, a sealing step of sealing the space between the semiconductor chip and the adherend that are flip-chip-bonded is performed. The sealing step is performed using a sealing resin. The sealing condition is not especially limited, and thermal curing of the sealing resin is performed normally by heating at 175° C. for 60 to 90 seconds. However, the present invention is not limited thereto, and the resin can be cured at 165 to 185° C. for a few minutes. In the heat treatment in this step, the thermosetting is performed not only on the sealing resin but also on the adhesive film. Accordingly, curing contraction occurs in both the sealing resin and the adhesive film as the thermosetting proceeds. As a result, the stress that is applied onto the semiconductor chip as a result of the curing contraction of the sealing resin can be canceled or relaxed by the curing contraction of the adhesive film. With this step, the adhesive film can be thermoset completely or almost completely, and the film can be pasted onto the backside of the semiconductor element with excellent adhesion. Further, because the adhesive film according to the present invention can be thermoset together with the sealing material during the sealing step even when the adhesive film is in an uncured state, there is no need to add another step for thermosetting the adhesive film.

The sealing resin is not especially limited as long as it is a resin having an insulation property (an insulating resin), and any material can be used appropriately selected from sealing materials such as known sealing resins. However, an insulating resin having elasticity is more preferable. An example thereof is a resin composition containing an epoxy resin. Examples of the epoxy resin include the epoxy resins described above. In the sealing resin with the resin composition containing an epoxy resin, a thermosetting resin other than the epoxy resin such as a phenol resin, and a thermoplastic resin may be contained as the resin component besides the epoxy resin. The phenol resin can be used also as a curing agent of the epoxy resin, and examples of the phenol resin include the phenol resins described above.

Because a semiconductor device (a flip-chip-mounted semiconductor device) that is manufactured using the adhesive film with a dicing sheet or the adhesive film has the adhesive film pasted onto the backside of the semiconductor chip, various marking methods can be performed with excellent visibility. Especially, even when the marking method is a laser marking method, the marking can be performed with an excellent contrast ratio, and various information such as character information and graphic information performed by laser marking can be visually recognized well. When performing the laser marking, a known laser marking apparatus can be used. Various lasers such as a gas laser, a solid laser, and a liquid laser can be used as the laser. Specifically, the gas laser is not especially limited, and a known gas laser can be used. However, a carbon dioxide gas laser such as a CO₂ laser, and an exima laser such as an ArF laser, a KrF laser, an XeCl laser, and an XeF laser are preferable. The solid laser is not especially limited, and a known solid laser can be used. However, a YAG laser such as an Nd:YAG laser and a YVO₄ laser are preferable.

Below, preferred examples of the present invention are explained in detail. However, materials, addition amounts, and the like described in these examples are not intended to limit the scope of the present invention, and are only examples for explanation as long as there is no description of limitation in particular. In addition, “part” means “parts by weight.”

### Example 1

### <Formation of Pressure-Sensitive Adhesive Layer>

An acrylic polymer A was obtained by charging 95 parts of 2-ethylhexyl acrylate (referred to as “2EHA” in the following), 5 parts of 2-hydroxyethyl acrylate (referred to as “HEA” in the following), and 65 parts of toluene into a reaction vessel equipped with a cooling tube, a nitrogen introducing tube, a thermometer, and a stirrer and polymerizing the contents at 61° C. for 6 hours in a nitrogen air flow.

Next, a pressure-sensitive adhesive composition solution was produced by adding 3 parts of a polyisocyanate compound (trade name “Colonate L” manufactured by Nippon Polyurethane Industry Co., Ltd.) to 100 parts of the acrylic polymer A.

A pressure-sensitive adhesive layer having a thickness of 10 μm was formed by applying the pressure-sensitive adhesive composition solution that was prepared as described above onto a polyethylene terephthalate film having a thickness of 50 μm and heat-crosslinking the product at 80° C. for 3 minutes. Next, the obtained pressure-sensitive adhesive layer was transferred onto a polyethylene film having a thickness of 100 μm.

Next, the surface of the pressure-sensitive adhesive layer was modified by spraying a silicone resin onto the surface using a silicone spray (trade name “KF96SP” manufactured by Shin-Etsu Chemical Co., Ltd.). The spraying amount was set so that the intensity of an Si—Kα ray became 0.01 kcps. With this operation, the dicing sheet according to this example was produced.

<Production of Adhesive Film with Dicing Sheet>

An adhesive composition solution having a concentration of 23.6% by weight was obtained by dissolving 50 parts of an epoxy resin (trade name “EPPN501HY” manufactured by Nippon Kayaku Co., Ltd.), 50 parts of a phenol resin (trade name “MEH7851” manufactured by Meiwa Plastic Industries, Ltd.), 100 parts of an acrylic copolymer (trade name “Revital AR31” manufactured by Nogawa Chemical Co., Ltd.), and 70 parts of spherical silica (trade name “S0-25R” manufactured by Admatechs Co., Ltd., average particle size 0.5 μm) as a filler in methylethylketone.

This adhesive composition solution was applied onto a release treated film (a releasing liner) made of a polyethylene terephthalate film having a thickness of 38 μm to which a silicone releasing treatment was performed, and then dried at 130° C. for 2 minutes. With this operation, an adhesive layer having a thickness of 10 μm formed. Further, the adhesive film with a dicing sheet according to this example was obtained by transferring the adhesive layer onto the pressure-sensitive adhesive layer.

### Example 2

The adhesive film with a dicing sheet according to this example was produced in the same manner as in Example 1 except that the amount of spraying with a silicone spray when modifying the surface of the pressure-sensitive adhesive layer was set so that the intensity of the Si—Kα ray became 100 kcps.

### Example 3

The adhesive film with a dicing sheet according to this example was produced in the same manner as in Example 1 except that a silicone resin was transferred onto the surface of the pressure-sensitive adhesive layer (the intensity of the Si—Kα ray on the surface of the pressure-sensitive adhesive layer was 0.9 kcps) using a silicone resin coating film (trade name “Diafoil MRA38” manufactured by Mitsubishi Plastics Inc.) when modifying the surface of the pressure-sensitive adhesive layer.

### Example 4

The adhesive film with a dicing sheet according to this example was produced in the same manner as in Example 1 except that a silicone resin was transferred onto the surface of the pressure-sensitive adhesive layer (the intensity of the Si—Kα ray on the surface of the pressure-sensitive adhesive layer was 1.2 kcps) using a silicone resin coating film (trade name “Diafoil MRF38” manufactured by Mitsubishi Plastics Inc.) when modifying the surface of the pressure-sensitive adhesive layer.

### Example 5

The adhesive film with a dicing sheet according to this example was produced in the same manner as in Example 1 except that the surface of the pressure-sensitive adhesive layer was modified (the intensity of the Si—Kα ray on the surface of the pressure-sensitive adhesive layer was 85 kcps) by applying a silicone dispersion (trade name “SD7226” manufactured by Dow Corning Toray Co., Ltd.) onto the surface and drying the dispersion at 70° C. for 5 minutes.

### Comparative Example 1

The adhesive film with a dicing sheet according to this comparative example was produced in the same manner as in Example 1 except that the amount of spraying with a silicone spray when modifying the surface of the pressure-sensitive adhesive layer was set so that the intensity of the Si—Kα ray became 0.001 kcps.

### Comparative Example 2

The adhesive film with a dicing sheet according to this comparative example was produced in the same manner as in Example 1 except that the amount of spraying with a silicone spray when modifying the surface of the pressure-sensitive adhesive layer was set so that the intensity of the Si—Kα ray became 0.005 kcps.

### Comparative Example 3

The adhesive film with a dicing sheet according to this comparative example was produced in the same manner as in Example 1 except that the amount of spraying with a silicone spray when modifying the surface of the pressure-sensitive adhesive layer was set so that the intensity of the Si—Kα ray became 200 kcps.

### Comparative Example 4

The adhesive film with a dicing sheet according to this comparative example was produced in the same manner as in Example 1 except that the amount of spraying with a silicone spray when modifying the surface of the pressure-sensitive adhesive layer was set so that the intensity of the Si—Kα ray became 500 kcps.

(Evaluation of the Peel adhesion)

The adhesive films with dicing sheets that were obtained in the examples and comparative examples were cut into rectangular pieces each having a tape width of 20 mm, and a tape (trade name “BT-315” manufactured by Nitto Denko Corporation, 20 mm wide) was pasted onto each of the adhesive layers. After that, the laminates were kept still in an environment of a temperature of 25° C. and a relative humidity of 55% Rh for 3minutes .

Next, the dicing sheet was peeled so that the angle between the surface of the pressure-sensitive adhesive layer and the surface of a silicon mirror wafer became 180°. At this time, the peeling speed was 300 mm/min. The result is shown in Table 1.

### (Dicing)

The dicing of the semiconductor wafer was actually performed using each of the adhesive films with dicing sheets of the examples and comparative examples in the following manner, and performance of each of the adhesive films with dicing sheets was evaluated.

The backside of a semiconductor wafer (diameter 8 inches, thickness 0.6 mm) was polished, and a mirror wafer having a thickness of 0.025 mm was used as a workpiece. The separator was peeled from the adhesive film with a dicing sheet, the mirror wafer was pasted onto the adhesive film by pressure-bonding with a roll at 40° C., and then dicing was performed. The dicing was performed in full-cut so that the chip size became a 10 mm-square. 100 semiconductor chips were formed by this dicing, and the number of semiconductor chips underwent chip fly was counted. The result is shown in Table 1.

### <Wafer Grinding Condition>

Grinding apparatus: DFG-8560 manufactured by DISCO Corporation

Semiconductor wafer: 8 inch diameter (the backside was ground from a thickness of 0.6 mm to 0.025 mm.)

### <Pasting Condition>

Pasting apparatus: MA-300011 manufactured by Nitto Seiki Co., Ltd.

Pasting speed: 10 mm/min

Pasting pressure: 0.15 MPa

Stage temperature during pasting: 40° C.

### <Dicing Condition>

Dicing apparatus: DFD-6361 manufactured by DISCO Corporation

Dicing ring: 2-8-1 manufactured by DISCO Corporation

Dicing speed: 30 mm/sec

Dicing blade: NBC-ZH226J27HAAA manufactured by DISCO Corporation

Dicing blade rotation speed: 40,000 rpm

Blade height: 0.085 mm

Cutting method: single step cut

Wafer chip size: 10.0 mm-square

### (Pickup)

The dicing of the semiconductor wafer was actually performed using each of the adhesive films with dicing sheets of the examples and comparative examples in the following manner, and then pickup was performed. The performance of each of the adhesive films with dicing sheets was evaluated.

The backside of a semiconductor wafer (diameter 8 inches, thickness 0.6 mm) was polished, and a mirror wafer having a thickness of 0.025 mm was used as a workpiece. The separator was peeled from the adhesive film with a dicing sheet, the mirror wafer was pasted onto the adhesive film by pressure-bonding with a roll at 40° C., and then dicing was performed. The dicing was performed in full-cut so that the chip size became a 10mm-square.

Next, the expanding step in which a space with a prescribed size is created between chips was performed by stretching each of the adhesive films with dicing sheets. The semiconductor chip was picked up by a method of pushing up the chip with a needle from the side of the base material of each of the adhesive films with dicing sheets, and then the pickup property was evaluated. Specifically, 100 semiconductor chips were sequentially picked up under the following condition, and the number of semiconductor chips that was not picked up was counted. The result is shown in Table 1.

### <Wafer Grinding Condition>

Grinding apparatus: DFG-8560 manufactured by DISCO Corporation

Semiconductor wafer: 8 inch diameter (the backside was ground from a thickness of 0.6 mm to 0.025 mm.)

### <Pasting Condition>

Pasting apparatus: MA-300011 manufactured by Nitto Seiki Co., Ltd.

Pasting speed: 10 mm/min

Pasting pressure: 0.15 MPa

Stage temperature during pasting: 40° C.

### <Dicing Condition>

Dicing apparatus: DFD-6361 manufactured by DISCO Corporation

Dicing ring: 2-8-1 manufactured by DISCO Corporation

Dicing speed: 30 mm/sec

Dicing blade: NBC-ZH226J27HAAA manufactured by DISCO Corporation

Dicing blade rotation speed: 30,000 rpm

Blade height: 0.085 mm

Cutting method: single step cut

Wafer chip size: 10.0 mm-square

### <Expanding Condition>

Die bonder: SPA-300 manufactured by Shinkawa Ltd.

Withdrawing amount of outer ring to inner ring: 3 mm

### <Pickup Condition>

Die bond apparatus: manufactured by Shinkawa Ltd.

Number of needles: 9 needles

Needle pushing distance: 300 μm

Needle pushing speed: 5 mm/sec

Collet maintaining time: 1 second

### (Result)

As is obvious from Table 1, chip fly when dicing the semiconductor wafer is prevented in Comparative Examples 1 and 2 because the tackiness of the pressure-sensitive adhesive layer to the adhesive layer was good. However, the adhesive strength of the pressure-sensitive adhesive layer was too high, and as a result, pickup failure occurred during pickup of the semiconductor chips. Further, all semiconductor chips were picked up well during pickup of the semiconductor chips in Comparative Examples 3 and 4 because the peeling property of the pressure-sensitive adhesive layer to the adhesive layer was good. However, the adhesive strength of the pressure-sensitive adhesive layer was too low, and as a result, chip fly occurred during dicing of the semiconductor wafer. Contrary to this, chip fly during dicing was prevented and the pickup property was good in Examples 1 and 2 because the balance of tackiness and the peeling property at the pasting surface of the pressure-sensitive adhesive layer with the adhesive layer was good.

TABLE 1

| | | | | | | Comparative | Comparative | Comparative | Comparative |
|---|---|---|---|---|---|---|---|---|---|
| | Example 1 | Example 2 | Example 3 | Example 4 | Example 5 | Example 1 | Example 2 | Example 3 | Example 4 |
| Si-Kα ray | 0.01 | 100 | 0.9 | 1.2 | 85 | 0.001 | 0.005 | 200 | 500 |
| intensity | | | | | | | | | |
| (kcps)eel | | | | | | | | | |
| adhesion | | | | | | | | | |
| Peel adhesion | 0.2 | 0.01 | 0.09 | 0.05 | 0.014 | 0.4 | 0.25 | 0.008 | 0.005 |
| (N/20 mm) | | | | | | | | | |
| Chip fly | 0/100 | 0/100 | 0/100 | 0/100 | 0/100 | 0/100 | 0/100 | 65/100 | 100/100 |
| Pickup property | 0/100 | 0/100 | 0/100 | 0/100 | 0/100 | 81/100 | 40/100 | 0/100 | 0/100 |

1. An adhesive film with a dicing sheet in which a pressure-sensitive adhesive layer and an adhesive layer are sequentially laminated on a base material, wherein
the intensity of an Si—Kα ray on at least one region on a surface of the pressure-sensitive adhesive layer to be pasted onto the adhesive layer is 0.01 to 100 kcps.

2. The adhesive film with a dicing sheet according to claim 1, wherein
the peel adhesion in the region is 0.01 to 0.2 N/20 mm to the adhesive layer when the pressure-sensitive adhesive layer is peeled at a temperature of 25° C., a relative humidity of 55%, a tensile speed of 300 mm/min, and a peeling angle of 180°.

3. The adhesive film with a dicing sheet according to claim 1, wherein the region corresponds to a region of the adhesive layer onto which a workpiece is to be pasted.

4. A method of manufacturing an adhesive film with a dicing sheet in which a pressure-sensitive adhesive layer and an adhesive layer are sequentially laminated on a base material, comprising the steps of:
forming a pressure-sensitive adhesive layer on a base material,
modifying at least one region of the surface of the pressure-sensitive adhesive layer so that the intensity of an Si—Kα ray becomes 0.01 to 100 kcps, and
forming an adhesive layer on the modified surface of the pressure-sensitive adhesive layer.

5. The method of manufacturing an adhesive film with a dicing sheet according to claim 4, wherein
the surface modification of the pasting surface of the pressure-sensitive adhesive layer is performed by spraying a solution containing at least a silicone resin in mist form.

6. The method of manufacturing an adhesive film with a dicing sheet according to claim 4, wherein
the surface modification of the pasting surface of the pressure-sensitive adhesive layer is performed by transferring a film to which a silicone resin is applied onto another film.

7. The method of manufacturing an adhesive film with a dicing sheet according to claim 4, wherein
the surface modification of the pasting surface of the pressure-sensitive adhesive layer is performed by applying a silicone dispersion onto the surface of the pressure-sensitive adhesive layer and drying the dispersion.

8. A semiconductor device that is manufactured using the adhesive film with a dicing sheet according to claim 1.

9. The adhesive film with a dicing sheet according to claim 2, wherein the region corresponds to a region of the adhesive layer onto which a workpiece is to be pasted.

10. The adhesive film with a dicing sheet according to claim 1, wherein the intensity of an Si—Kα ray is determined by x-ray fluorescence using a vertical Rh tube under conditions of an analysis area 300 mmφ, a dispersive crystal of RX4, and an output 50 kV and 70 mA.
